(19) United States
(12) Patent Application Publication
(10) Pub. No.: US 2026/0304283 A1
(43) Pub. Date: Oct. 1, 2026

(54) COMMUNICATION MANAGEMENT IN WEARABLE DEVICES

(71) Applicant: Samsung Electronics Co., Ltd., Suwon-si (KR)

(72) Inventors: Vishnu Vardhan Ratnam, Frisco, TX (US); Bilal Sadiq, Plano, TX (US); Boon Loong Ng, Plano, TX (US); Vutha Va, Plano, TX (US)

(21) Appl. No.: 19/575,630

(22) Filed: Mar. 23, 2026

Related U.S. Application Data
(60) Provisional application No. 63/778,114, filed on Mar. 26, 2025.

(51) Int. Cl. H04W 40/12; H04B 1/3827; H04B 13/00

(52) U.S. Cl. CPC H04W 40/12; H04B 1/385; H04B 13/005

(57) ABSTRACT

A method includes performing, by a first electronic device, discovery of a second electronic device and one or more communication modes associated with the second electronic device, the one or more communication modes including a human body communication mode; performing, by the first electronic device, an association procedure with the second electronic device on a first communication mode; selecting, by the first electronic device, a second communication mode to communicate with the second electronic device; and performing, by the first electronic device, communication with the second electronic device in the second communication mode.

### CROSS-REFERENCE TO RELATED APPLICATION AND CLAIM OF PRIORITY

The present application claims priority under 35 U.S.C. § 119 (e) to U.S. Provisional Patent Application No. 63/778,114 filed on Mar. 26, 2025, which is hereby incorporated by reference in its entirety.

### TECHNICAL FIELD

This disclosure relates generally to wireless networks. More specifically, this disclosure relates to a method and apparatus for communication management in wearable devices.

### BACKGROUND

The demand of wireless data traffic is rapidly increasing due to the growing popularity among consumers and businesses of smart phones and other mobile data devices, such as tablets, “note pad” computers, net books, eBook readers, and machine type of devices. In order to meet the high growth in mobile data traffic and support new applications and deployments, improvements in radio interface efficiency and coverage are of paramount importance.

In addition, with the growth of demand for bio-medical monitoring, augmented reality (AR), virtual reality (VR), extended reality (XR), and smart home applications, there has been an uptick in interest in wearable products such as smart watch, wireless ear buds, smart ring, AR glasses and VR/XR headset. Performance requirements for these products can be significantly different and various power saving mechanisms for these products are being explored.

### SUMMARY

This disclosure provides apparatuses and methods for communication management in wearable devices.

In one embodiment, a method may include performing, by a first electronic device, discovery of a second electronic device and one or more communication modes associated with the second electronic device, the one or more communication modes including a human body communication mode (HBC). The method may further include performing, by the first electronic device, an association procedure with the second electronic device on a first communication mode. The method may also include selecting, by the first electronic device, a second communication mode to communicate with the second electronic device. The method may also include performing, by the first electronic device, communication with the second electronic device in the second communication mode.

In another embodiment, a first electronic device is provided. The first electronic device may include a memory and a processor operably coupled to the memory. The processor may be configured to perform discovery of a second electronic device and one or more communication modes associated with the second electronic device, the one or more communication modes including a HBC. The processor may be further configured to perform an association procedure with the second electronic device on a first communication mode, select a second communication mode to communicate with the second electronic device, and perform communication with the second electronic device in the second communication mode.

In yet another embodiment, a non-transitory computer readable medium embodying a computer program is provided. The computer program may include program code that, when executed by a processor of a first electronic device, causes the first electronic device to: perform discovery of a second electronic device and one or more communication modes associated with the second electronic device, the one or more communication modes including a HBC; perform an association procedure with the second electronic device on a first communication mode; select a second communication mode to communicate with the second electronic device; and perform communication with the second electronic device in the second communication mode.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of this disclosure and its advantages, reference is now made to the following description, taken in conjunction with the accompanying drawings, in which:

FIG. 1 illustrates an example network configuration including an electronic device in accordance with example embodiments of the present disclosure;

FIG. 2 illustrates an example scenario of a wearable device communicating with a peer device in accordance with example embodiments of the present disclosure;

FIG. 3 illustrates example communication options between the wearable device and the peer device in accordance with example embodiments of the present disclosure;

FIG. 4 illustrates an example periodic discovery in accordance with example embodiments of the present disclosure;

FIG. 5 illustrates an example algorithm for communication mode selection in accordance with example embodiments of the present disclosure;

FIG. 6 illustrates an example mode switching during communication between a wearable device and a peer device in accordance with example embodiments of the present disclosure;

FIG. 7 illustrates an example switching control layer during communication between a wearable device and a peer device in accordance with example embodiments of the present disclosure;

FIG. 8 illustrates a flow diagram of an example communication method performed by a wearable device and a peer device in accordance with example embodiments of the present disclosure; and

FIG. 9 illustrates a flow chart of an example communication method between a wearable device and a peer device in accordance with example embodiments of the present disclosure.

### DETAILED DESCRIPTION

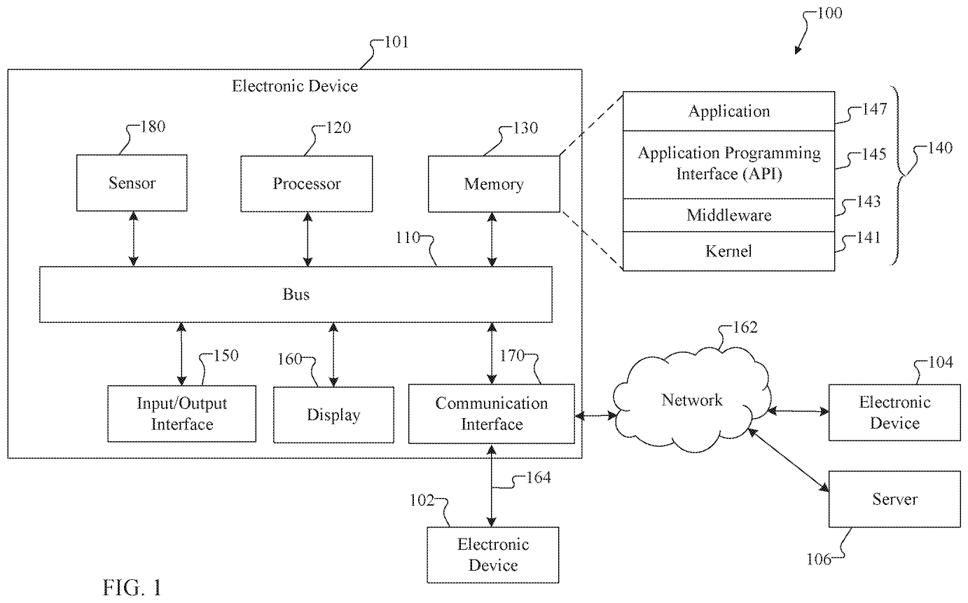

FIGS. 1 through 9, discussed below, and the various embodiments used to describe the principles of this disclosure in this patent document are by way of illustration only and should not be construed in any way to limit the scope of the disclosure. Those skilled in the art will understand that the principles of this disclosure may be implemented in any suitably arranged wireless communication system.

With the growth of demand for bio-medical monitoring, augmented reality (AR), virtual reality (VR), extended reality (XR), and smart home applications, there has been an increased interest in wearable products such as smart watch, wireless ear buds, smart ring, AR glasses, VR/XR headset. Performance requirements for these products may be significantly different. An important requirement for such devices may be low weight and a long battery life. Table 1 below shows some of the meaningful performance goals or requirements.

TABLE 1
Performance requirements for different wearable products

| | | | Req. | Desired Battery | |
|---|---|---|---|---|---|
| Product | Req. Throughput | | Latency | Life | |
| Smart Watch | <500 Kbps | | — | 1-2 | days |
| Wireless Buds | ~250 Kbps | | 50 ms | 24 | hours |
| Smart Ring | <100 Kbps | | — | 7 | days |
| AR Glass | ~10 Mbps | (1K, 30 fps) | 15 ms | 8+ | hours |
| VR Headset | ~100 Mbps | (4K, 360°) | 15 ms | 4+ | hours |

While the present disclosure provides example embodiments using AR Glass and VR headsets, the provided solutions and ideas may also be applicable to other wearable products. Table 2 shows the performance parameters supported by wireless communication technologies.

TABLE 2
Performance supported by Wi-Fi and BLE technologies

| | Throughput | | | Power | |
|---|---|---|---|---|---|
| Technology | (Mbps) | Latency (ms) | | Consumption (mW) | |
| Wi-Fi (80 MHz, | 40 | >50 | ms | ~22 | mW |
| 2.4 GHz) | | | | | |
| BLE (2.4 GHz) | <2 | 6 | ms | 5 | mW |

As evident from Tables 1 and 2, for many AR/VR applications, wireless communication solutions such as Wi-Fi and Bluetooth Low Energy (BLE) technology may be insufficient to meet the performance requirements. This may be due to several considerations, such as:
Pathloss considerations: The pathloss at 2.4 GHz may be high in close proximity to human body due to the strong signal absorption by the human body. The pathloss at ~1 m distance may be around 60~80 dB. This may utilize higher transmit (TX) power even for short communication distance.
Data Rate considerations: The maximum throughput supported by BLE in 2 Mbps which can be insufficient for AR/VR applications. Wi-Fi may meet the throughput, but in low/moderate channel contention scenarios.
Power consumption considerations: A Wi-Fi chip may consume >20 mW power. For battery size of 600 mWh and 10-hour desired life, ~30% power may be consumed by the Wi-Fi chip.
Latency considerations: The latency of Wi-Fi at 2.4 GHz may be 50+ ms, which may be insufficient due to channel contention. The situation may be better in other frequency bands.

Correspondingly, there may be a need for new communication technologies which may help satisfy the different requirements for AR glasses and VR headsets. In contrast to wireless communication technologies which transmit the signal through the air, another prospective communication technology for wearables may be Human Body Communication (HBC). The HBC may utilize the human tissue as the medium for transmission of signals between transceivers placed in close proximity to the human body. The HBC may offer several “potential” benefits compared to wireless communication at 2.4 GHz:
There may be limited (if any) channel contention, and the channel may be person-specific, thus providing low latency.
The pathloss may be orders of magnitude lower than 2.4 GHz (in some scenarios), allowing lower transmit power for same target SNR.
The transmission may be at a low carrier frequency, not requiring up-conversion to RF. This may reduce hardware cost and power consumption.
The signal may be confined to human body and difficult to eavesdrop, providing enhanced security.

There may be three types of the HBC:
Galvanic coupling: The transmitter electrodes may be in direct contact with the skin and induce an ionic current in the body. A portion of the ionic current may spread across the human body and induce a potential across the receiver electrodes. This may be measured using a differential amplifier at the receiver (RX) which is in direct contact with the skin.
Capacitive coupling: The transmitter electrodes placed near the human body may couple an electric field to the body. Some of the field lines may propagate back to the negative terminal via the receiver back and the ground.
Magnetic coupling: A transmitter coil may induce a magnetic field into the human body and a receiver coil may tap this magnetic field to generate an electric signal.

Based on a survey of the three HBC types, the capacitive coupling (also referred to herein as Cap. Cpl.) may be a suitable technology for meeting the requirements of the AR/VR applications. With the capacitive coupling, up to 10× reduction in power consumption may be expected as compared to BLE, and data rates up to 20-100 Mbps may be expected. Table 3 below shows the expected performance parameters for capacity coupling-based HBC.

TABLE 3
Performance supported by Capacitive Coupling HBC

| | | | | Power | | |
|---|---|---|---|---|---|---|
| Technology | Pathloss | Effective BW | Data Rate | Consumption | | Latency |
| Cap. Cpl. | 60-70 dB | 20 MHz | ~20 Mbps | <500 | μW | May be |
| @21 MHz | | | | | | designed |
| Cap. Cpl. | 50-60 dB | 100 MHz | ~100 Mbps | <1 | mW | May be |
| @100 MHz | | | | | | designed |

Experimental investigations on Capacitive Coupling-based HBC have shown that the channel pathloss and frequency response may be significantly impacted by surroundings of the human subject and location of wearable devices on the body. Examples of such impacts may include:
Distance to ground may cause a significant change in the 3 dB bandwidth of the channel.
The transmit/receive device thickness may cause up to 10 dB change in pathloss.
Position of the electrodes on the body may cause a variation of up to 20 dB in the pathloss.
Posture variation of the human subject may cause up to 10 dB variation in the pathloss.

Communication using the human body has also been standardized before in the context of body area networks. The IEEE 802.15.6 standard developed in 2010 focused on communication for body area networks. It defines two types of devices: Nodes and a Hub (that acts as a gateway). For example, Phone=Hub, Node=AR/VR Glass, etc. Three types of PHY layers were considered in this standard, one of which is the HBC via electric field communication. For the HBC in IEEE 802.15.6, the transmit frequency was set to 21 MHz and the maximum supported data rate as 1.3 Mbps.

To reduce the high-power consumption of Wi-Fi chips, several power saving mechanisms have been proposed in Wi-F standards. Examples of these may include:
Target Wake Time (TWT): This mechanism was first defined in the IEEE 802.11ax standard and has two types of operation: individual TWT and a broadcast TWT. In TWT, two peer Wi-Fi devices may negotiate periodic service periods or intervals for exchange of information with each other. Correspondingly, the Wi-Fi device may remain in doze state outside of these service periods to save power.
Enhanced Multi-link Single Radio (EMLSR): This mechanism was first defined in the IEEE 802.11be standard and involves a multi-link Wi-Fi device normally operating in a listen state by default. The listen state has reduced transmit/receive capabilities, and consumes very low power. When a peer device initiates a frame exchange with the EMLSR device with an appropriate initial control frame, the EMLSR device may reconfigure its hardware to have full transmit and receive capabilities for the duration of the frame exchange to allow higher throughput data transmission. The EMLSR device may also borrow radios from other links during this frame exchange. After the end of the frame exchange the EMLSR device may again return back to the listen state to save power.
Dynamic Power Save (DPS): In order to reduce power consumption, and yet minimize the degradation in performance for latency sensitive traffic, DPS operation is being considered in the discussions for the IEEE 802.11bn standard. In DPS mode, by default the Wi-Fi device may operate with reduced capabilities, e.g., one or more of reduced channel width, support for limited Physical Protocol Data Unit (PPDU) formats, a reduced MCS set and NSS set. Operating with reduced capabilities may enable the device to save power. When a peer device initiates a frame exchange with the DPS device with an appropriate initial control frame, the EMLSR device may reconfigure its hardware to have full transmit and receive capabilities for the duration of the frame exchange to allow higher throughput data transmission. After the end of the frame exchange the DPS device may again return back to the reduced capabilities to save power.

Although the HBC may provide a low power communication solution that is attractive for the wearable devices, it may suffer from several challenges. Firstly, since it utilizes human body as the medium, it may work when the wearables are on the human body or in close proximity to the body. In other words, it may be opportunistically available and may suffer from sudden interruption when the devices are removed from the body. Secondly, HBC channel pathloss and frequency response may be significantly impacted by the surroundings of the human body, posture of the human body, orientation of the wearables, etc., thus utilizing fast adaptation to channel variations. Finally, the presence of multiple communication modes (Wi-Fi/BLE/UWB/HBC) on a wearable device may drastically increase power consumption, viz. a KPI for wearables unless each mode is used judiciously.

The present disclosure provides various techniques supporting communication management in wearable devices that addresses, e.g. the problems with the HBC. By allowing discovery of one or more communication modes associated with a peer device, the embodiments of the present disclosure enables the wearable device and associated with peer device to select and switch to an appropriate communication mode as needed (e.g., upon a posture change). Further, by providing various power saving mechanisms for each communication mode, the embodiments of the present disclosure provides power-efficient operations for each communication mode.

The example embodiments of communication methods, communication management, and other relevant features in according with the present disclosure are illustrated in FIGS. 1-9.

FIG. 1 illustrates an example network configuration 100 including an electronic device in accordance with this disclosure. The embodiment of the network configuration 100 shown in FIG. 1 is for illustration only. Other embodiments of the network configuration 100 could be used without departing from the scope of this disclosure.

According to embodiments of this disclosure, an electronic device 101 is included in the network configuration 100. The electronic device 101 can include at least one of a bus 110, a processor 120, a memory 130, an input/output (I/O) interface 150, a display 160, a communication interface 170, and a sensor 180. In some embodiments, the electronic device 101 may exclude at least one of these components or may add at least one other component. The bus 110 includes a circuit for connecting the components 120-180 with one another and for transferring communications (such as control messages and/or data) between the components.

The processor 120 includes one or more processing devices, such as one or more microprocessors, microcontrollers, digital signal processors (DSPs), application specific integrated circuits (ASICs), or field programmable gate arrays (FPGAs). In some embodiments, the processor 120 includes one or more of a central processing unit (CPU), an application processor (AP), a communication processor (CP), a graphics processor unit (GPU), or a neural processing unit (NPU). The processor 120 is able to perform control on at least one of the other components of the electronic device 101 and/or perform an operation or data processing relating to communication or other functions. As described below, the processor 120 may perform one or more functions related to communication methods among wearable devices.

The memory 130 can include a volatile and/or non-volatile memory. For example, the memory 130 can store commands or data related to at least one other component of the electronic device 101. According to embodiments of this disclosure, the memory 130 can store software and/or a program 140. The program 140 includes, for example, a kernel 141, middleware 143, an application programming interface (API) 145, and/or an application program (or “application”) 147. At least a portion of the kernel 141, middleware 143, or API 145 may be denoted an operating system (OS).

The kernel 141 can control or manage system resources (such as the bus 110, processor 120, or memory 130) used to perform operations or functions implemented in other programs (such as the middleware 143, API 145, or application 147). The kernel 141 provides an interface that allows the middleware 143, the API 145, or the application 147 to access the individual components of the electronic device 101 to control or manage the system resources. The application 147 may include one or more applications that, among other things, support communication methods among wearable devices in accordance with the present disclosure. These functions can be performed by a single application or by multiple applications that each carries out one or more of these functions. The middleware 143 can function as a relay to allow the API 145 or the application 147 to communicate data with the kernel 141, for instance. A plurality of applications 147 can be provided. The middleware 143 is able to control work requests received from the applications 147, such as by allocating the priority of using the system resources of the electronic device 101 (like the bus 110, the processor 120, or the memory 130) to at least one of the plurality of applications 147. The API 145 is an interface allowing the application 147 to control functions provided from the kernel 141 or the middleware 143. For example, the API 145 includes at least one interface or function (such as a command) for filing control, window control, image processing, or text control.

The I/O interface 150 serves as an interface that can, for example, transfer commands or data input from a user or other external devices to other component(s) of the electronic device 101. The I/O interface 150 can also output commands or data received from other component(s) of the electronic device 101 to the user or the other external device.

The display 160 includes, for example, a liquid crystal display (LCD), a light emitting diode (LED) display, an organic light emitting diode (OLED) display, a quantum-dot light emitting diode (QLED) display, a microelectromechanical systems (MEMS) display, or an electronic paper display. The display 160 can also be a depth-aware display, such as a multi-focal display. The display 160 is able to display, for example, various contents (such as text, images, videos, icons, or symbols) to the user. The display 160 can include a touchscreen and may receive, for example, a touch, gesture, proximity, or hovering input using an electronic pen or a body portion of the user.

The communication interface 170, for example, is able to set up communication between the electronic device 101 and an external electronic device (such as a first electronic device 102, a second electronic device 104, or a server 106). For example, the communication interface 170 can be connected with a network 162 or 164 through wireless or wired communication to communicate with the external electronic device. The communication interface 170 can be a wired or wireless transceiver or any other component for transmitting and receiving signals.

The wireless communication is able to use at least one of, for example, WiFi, long term evolution (LTE), long term evolution-advanced (LTE-A), 5th generation wireless system (5G), millimeter-wave or 60 GHz wireless communication, Wireless USB, code division multiple access (CDMA), wideband code division multiple access (WCDMA), universal mobile telecommunication system (UMTS), wireless broadband (WiBro), or global system for mobile communication (GSM), as a communication protocol. The wired connection can include, for example, at least one of a universal serial bus (USB), high definition multimedia interface (HDMI), recommended standard 232 (RS-232), or plain old telephone service (POTS). The network 162 or 164 includes at least one communication network, such as a computer network (like a local area network (LAN) or wide area network (WAN)), Internet, or a telephone network.

The electronic device 101 further includes one or more sensors 180 that can meter a physical quantity or detect an activation state of the electronic device 101 and convert metered or detected information into an electrical signal. For example, the sensor(s) 180 can include one or more cameras or other imaging sensors, which may be used to capture image frames of scenes. The sensor(s) 180 can also include one or more buttons for touch input, one or more microphones, a depth sensor, a gesture sensor, a gyroscope or gyro sensor, an air pressure sensor, a magnetic sensor or magnetometer, an acceleration sensor or accelerometer, a grip sensor, a proximity sensor, a color sensor (such as a red green blue (RGB) sensor), a bio-physical sensor, a temperature sensor, a humidity sensor, an illumination sensor, an ultraviolet (UV) sensor, an electromyography (EMG) sensor, an electroencephalogram (EEG) sensor, an electrocardiogram (ECG) sensor, an infrared (IR) sensor, an ultrasound sensor, an iris sensor, or a fingerprint sensor. Moreover, the sensor(s) 180 can include one or more position sensors, such as an inertial measurement unit that can include one or more accelerometers, gyroscopes, and other components. In addition, the sensor(s) 180 can include a control circuit for controlling at least one of the sensors included here. Any of these sensor(s) 180 can be located within the electronic device 101.

In some embodiments, the electronic device 101 can be a wearable device or an electronic device-mountable wearable device (such as an HMD). For example, the electronic device 101 may represent an XR wearable device, such as a headset or smart eyeglasses. In other embodiments, the first external electronic device 102 or the second external electronic device 104 can be a wearable device or an electronic device-mountable wearable device (such as an HMD). In those other embodiments, when the electronic device 101 is mounted in the electronic device 102 (such as the HMD), the electronic device 101 can communicate with the electronic device 102 through the communication interface 170. The electronic device 101 can be directly connected with the electronic device 102 to communicate with the electronic device 102 without involving with a separate network.

The first and second external electronic devices 102 and 104 and the server 106 each can be a device of the same or a different type from the electronic device 101. According to certain embodiments of this disclosure, the server 106 includes a group of one or more servers. Also, according to certain embodiments of this disclosure, all or some of the operations executed on the electronic device 101 can be executed on another or multiple other electronic devices (such as the electronic devices 102 and 104 or server 106). Further, according to certain embodiments of this disclosure, when the electronic device 101 should perform some function or service automatically or at a request, the electronic device 101, instead of executing the function or service on its own or additionally, can request another device (such as electronic devices 102 and 104 or server 106) to perform at least some functions associated therewith. The other electronic device (such as electronic devices 102 and 104 or server 106) is able to execute the requested functions or additional functions and transfer a result of the execution to the electronic device 101. The electronic device 101 can provide a requested function or service by processing the received result as it is or additionally. To that end, a cloud computing, distributed computing, or client-server computing technique may be used, for example. While FIG. 1 shows that the electronic device 101 includes the communication interface 170 to communicate with the external electronic device 104 or server 106 via the network 162 or 164, the electronic device 101 may be independently operated without a separate communication function according to some embodiments of this disclosure.

The server 106 can include the same or similar components as the electronic device 101 (or a suitable subset thereof). The server 106 can support to drive the electronic device 101 by performing at least one of operations (or functions) implemented on the electronic device 101. For example, the server 106 can include a processing module or processor that may support the processor 120 implemented in the electronic device 101. The server 106 may perform one or more functions related to communication methods among wearable devices.

Although FIG. 1 illustrates one example of a network configuration 100 including an electronic device 101, various changes may be made to FIG. 1. For example, the network configuration 100 could include any number of each component in any suitable arrangement. In general, computing and communication systems come in a wide variety of configurations, and FIG. 1 does not limit the scope of this disclosure to any particular configuration. Also, while FIG. 1 illustrates one operational environment in which various features disclosed in this patent document can be used, these features could be used in any other suitable system.

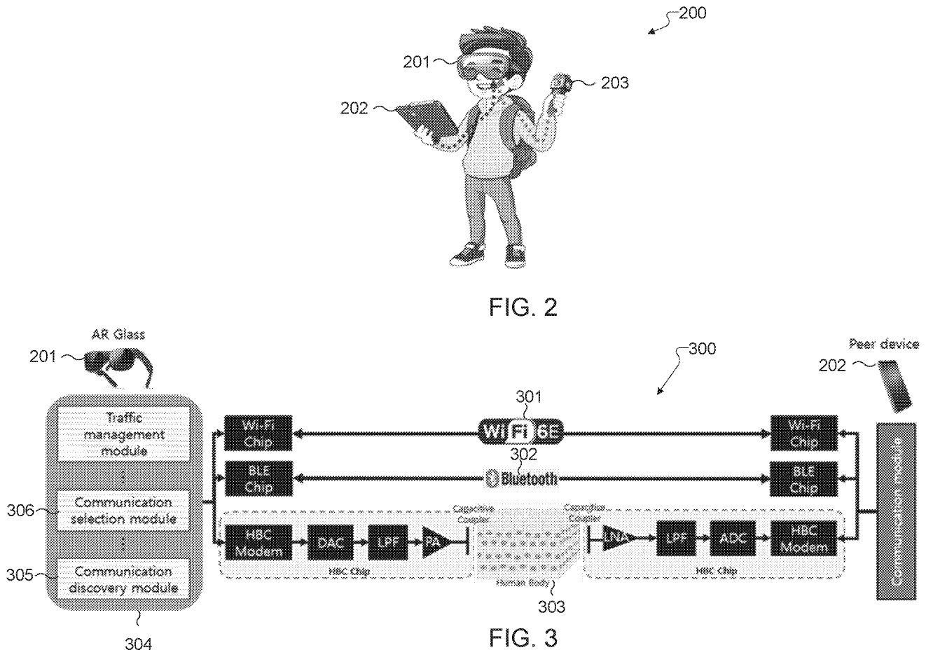

FIGS. 2 and 3 illustrate an example scenario 200 of a wearable device communicating with a peer device and example communication options 300 between the wearable device and the peer device, respectively, in accordance with example embodiments of the present disclosure.

In FIGS. 2 and 3, the wearable device may be, e.g., a pair of AR glasses 201 and the peer devices may be, e.g., a smart phone 202 or other electronic devices (e.g., a camera) 203. In the example scenario 200, the AR glasses 201 may intend to communicate with one or more of the peer devices, such as the smart phone 202. The example scenario and options shown in FIGS. 2 and 3 are for illustration only. For example, the provided solutions and ideas in accordance of this disclosure may be applicable to any other wearable products. Further, the provided solutions may be also applicable to other scenarios of communication between peer devices via a medium where the medium may be different from the human body, such as a specially designed table mat, wall etc.

In FIG. 3, multiple communication options (such as HBC 303, Bluetooth® 302 and Wi-Fi 301) between the AR glasses 201 and the peer devices 202, 203 may be present. However, this is for illustration only, and the provided solutions may be utilized when the different communication options may be present, e.g., Ultra-wide-band (UWB).

The wearable device 201 may include a communication module 304, which may control the different communication chips present in the wearable device 201. For example, the communication module 304 may control the buffering and routing of the buffered traffic to the different chips, the power management of the different chips, etc.

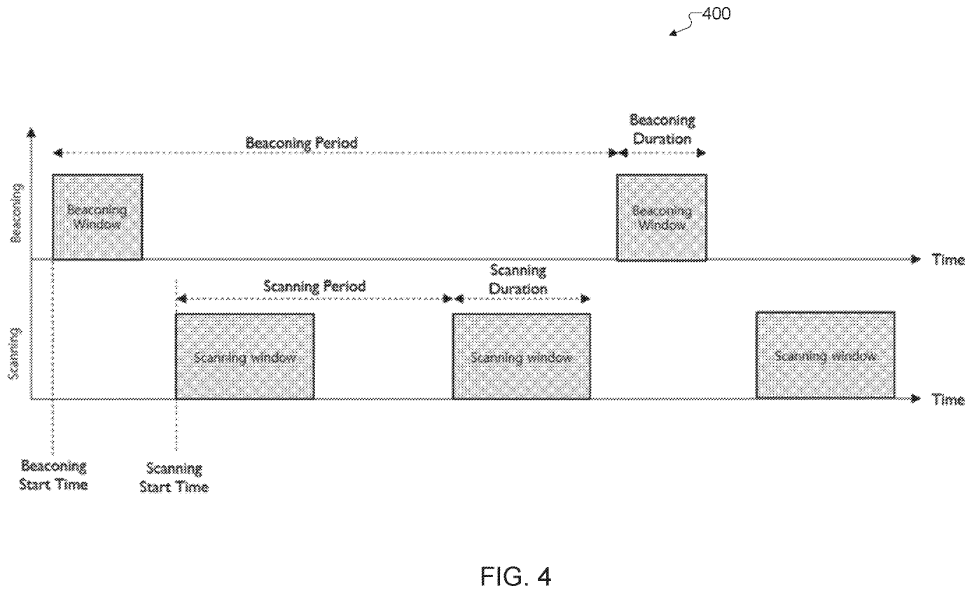

In one embodiment, the wearable device 201 may also include a communication discovery module 305. The communication discovery module 305 may periodically transmit discovery packets or scan for discovery packets to identify other available devices in one or more communication modes such as Wi-Fi 301, Bluetooth® 302 and HBC 303. The HBC 303 may include one or more HBC technologies. In one embodiment, the communication discovery module 305 may include separate sub-modules for performing discovery for each communication mode. In one embodiment, the periodicity of the scanning may be different for each mode and adaptive depending on one or more parameters such as the applicable communication, the battery state of the wearable device 201, the traffic requirements of the wearable device 201 and contextual information of the wearable device 201. An example of a periodic discovery or scanning is illustrated in FIG. 4.

In one embodiment, the communication discovery module 305 may also be triggered by a specific event, such as arrival of traffic, battery power draining below a threshold while using a more power-expensive communication mode, degradation of KPIs of traffic below a threshold, a trigger indicating potential presence of a discoverable device etc. For example, the HBC discovery module may be triggered based on side information received via Wi-Fi or Bluetooth that there may be a discoverable device on the body or via using the AR Glass camera visual information. The communication discovery module 305 at any time may maintain a list of currently discovered devices on each communication mode.

In one embodiment, there may be one communication mode on which the discovery of a peer device may be always initiated, e.g., BLE. This mode may be called, for example, a discovery link. Once new devices are discovered on the discovery link, the devices may exchange available communication modes on both devices, and based on the exchanged information, the discovery on one or more other communication modes may be triggered.

In one embodiment after two peer devices discover each other, if they intend to associate, they may exchange information regarding one or more of:
Their identifiers and device types,
Their capabilities,
Available communication modes,
Other communication parameters, etc.

In one embodiment, to save power and other costs, some of the available communication modes may be unidirectional, i.e. transmit only or receive only. In this case, another communication mode may be used to receive information in the reverse direction.

In one embodiment, if a wearable device no longer wishes to exchange information with a peer device, the wearable device may follow a disassociation procedure with the peer device.

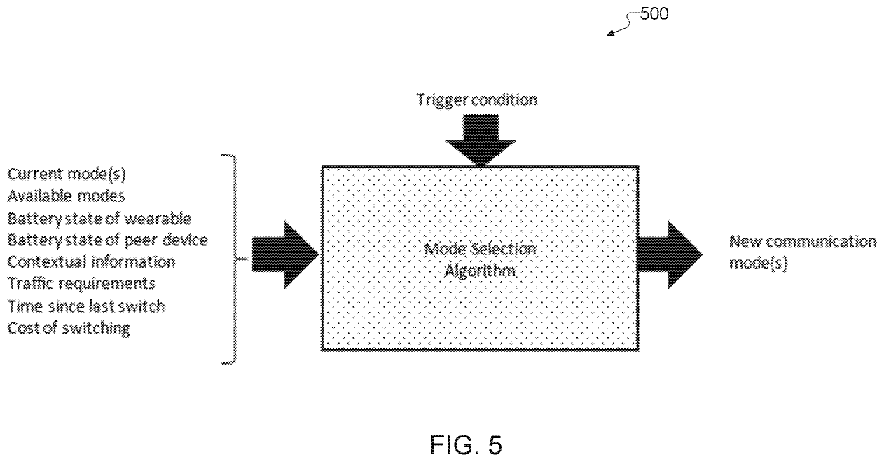

In one embodiment, the wearable device may also include a communication selection module 306 as illustrated in FIG. 5.

FIG. 4 illustrates an example periodic discovery 400 in accordance with example embodiments of the present disclosure. The example periodic discovery of FIG. 4 is for illustration only.

In FIG. 4, the example periodic discovery 400 may include scanning windows and beaconing windows for a wearable device. For each communication mode, there may be separate parameters for determining the scanning windows and beaconing windows. The scanning windows may be periodic time windows during which the wearable device is scanning for incoming discovery beacons/packets. The beaconing windows may be periodic time windows during which the wearable device may transmit beacon or discovery packets so that other devices may discover the wearable device.

FIG. 5 illustrates an example algorithm 500 for communication mode selection in accordance with example embodiments of the present disclosure. The example algorithm 500 shown in FIG. 5 is for illustration only. One or more of the components illustrated in FIG. 5 may be implemented in specialized circuitry configured to perform the noted functions or one or more of the components may be implemented by one or more processors executing instructions to perform the noted functions. Other embodiments of communication mode selection algorithms could be used without departing from the scope of this disclosure.

In one embodiment, a wearable device may include a communication selection module (e.g., the communication selection module 306 of FIG. 3). The communication selectin module may determine which communication mode to utilize for information exchange with a peer device, based on the result of the communication discovery module (e.g., the communication discovery module 305 of FIG. 3). The communication selection module may query the discovery module of the currently available modes for the communication mode selection. The communication selection module may run periodically for each discovered peer device for which there is traffic available or for which traffic is expected, where the periodicity may be adaptive depending on one or more parameters such as:

The battery state of the wearable device
The traffic requirements of the wearable device
Contextual information of the wearable device

In one embodiment, the communication selection module may also be triggered by a specific event, such as arrival of traffic, battery power draining below a threshold, degrading KPIs of traffic, a trigger indicating availability of a new mode, etc.

In one embodiment, the algorithm 500 for selection of the communication mode may be based on one or more of:
Currently being used communication mode, if any.
Available communication modes
Battery state of the wearable device
Battery state of the peer device
The data traffic requirements (e.g., throughput, latency)
Parameters of the communication mode, e.g. supported throughput, latency, average power consumption, link reliability, etc.
Time since the last change to the communication mode
Costs (power, latency, etc.) involved in performing a communication mode switch.
Whether the association or set up of link is already performed on the communication modes, etc.

In one embodiment, the communication mode selection decision may be taken at one of the peer devices and the indication may be sent to the other device via the currently used communication mode. In one embodiment, when two peer devices discover each other and perform an association, they may decide which device may be responsible for the communication mode selection. In one embodiment, any of the two devices may perform the communication mode selection decision. In one embodiment, the mode switch may be mandatory by the peer device, while in another embodiment, it may be a negotiation.

In one example of the algorithm, the inputs may include the requirements of current traffic flows, currently available communication modes, and battery level of the wearable device. Each communication mode may also have some indication parameters of the throughput and latency they can support. These may be pre-determined or can be side information estimated by some other observable parameters. Then, the following rules may be applied:
If the battery power of the wearable device is above a first threshold, the available communication mode with the lowest power consumption that supports the throughput and latency demands of the currently running applications can be the one selected.
If the battery power is below a second threshold, the available communication mode with the lowest power consumption may be selected for running the applications.

In one embodiment, more than one communication mode may be selected to be used simultaneously. In this case, the joint power consumption of the selected modes and their aggregate throughput and/or latency may be the parameters considered. In one embodiment, the costs (power for turn-on/turn-off, delay in re-routing traffic etc.) of changing the communication mode may also be considered to prevent frequent ping-pong across two similar choices of modes. For example, once a change in mode is made, then the requirements for performing a switch to another mode may be raised for a certain cool-down time.

In one embodiment in which the communication mode selection decision has been made, the wearable device may send an indication to the peer device via the currently used communication mode. This indication may be referred to as, for example, a Mode-Switch Request or Mode Switch Notification message. The mode switch request may include one or more of:
An identifier of the device sending the request.
An identifier of the device to which the request is being sent.
An indication of the one or more communication mode(s) which should be used for the data flows.
An indication of one or more parameters associated with communication in the new mode(s).
An indication of the data flow(s) which should be re-routed to the new communication mode(s).
A dialog token identifying each request message uniquely.
An indication of the time stamp at which the request is being made.
A reason code indicating the reason for the request to switch.
An indication of the urgency of the switch and whether the request is negotiable or not, etc.

In one embodiment, when two peer devices discover each other and perform an association, they may decide which device may be responsible for sending the Mode Switch Request or Notification message. In one embodiment, upon receiving the Mode Switch Request or Notification message, the peer device may be required to comply with the request. In another embodiment, there may be a negotiation process involved in performing the mode switch, where after sending the Mode Switch Request message, the peer device may send a Mode Switch Response frame, which either confirms the request or rejects the request with an appropriate reason for the rejection. The Mode Switch Response frame, upon rejection, may also recommend an alternative communication mode to be used, which it is willing to accept. In another variant, the behavior of the two peer devices may be dependent on their capabilities, battery levels, and requirements. As an example, in one case, a pair of AR glasses may be allowed to send a Mode Switch Notification which a Smart phone has to comply with. While the Smart phone may always need to negotiate the mode switch with the AR Glass.

In one embodiment, turning on a communication mode and setting up of the corresponding link to initiate frame exchange may take significant time. To avoid service interruption of traffic flows, in one embodiment, the older communication mode may still be maintained and used for data transmission while the new mode is being set up. After the new mode is ready, then the traffic may be re-routed and the older mode may be terminated.

In one embodiment, the wearable device may select a communication mode as a backup mode which is always on and/or on which the link setup is always maintained. This mode may be, for example, the Bluetooth link. In one example, when performing communication switch to a new mode, all traffic may be temporarily rerouted to this backup mode until the new link is set up. In another example, if there is a sudden interruption of service in any mode, the traffic may be re-routed to this backup mode until that mode is recovered or until an appropriate alternative mode is found.

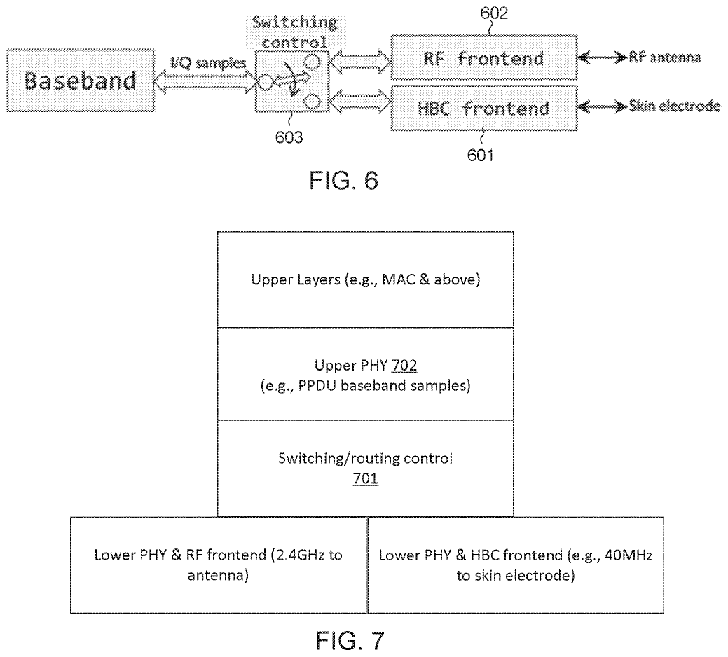

FIGS. 6 and 7 illustrate an example mode switching 600 and an example switching control layer 700 during the communication between a wearable device and a peer device in accordance with example embodiments of the present disclosure. The example mode switching and switching control layer shown in FIGS. 6 and 7 are for illustration only. One or more of the components illustrated in FIGS. 6 and 7 may be implemented in specialized circuitry configured to perform the noted functions or one or more of the components may be implemented by one or more processors executing instructions to perform the noted functions. Other embodiments of mode switching and/or switching control could be used without departing from the scope of this disclosure.

One approach to utilize Human Body Channel and enable the HBC mode may be to transmit and receive the baseband signals of RF communication technology through Human Body Channel frontend.

As illustrated in FIG. 6, in some embodiments, HBC may be added to the device by transmitting/receiving BLE or 802.11/Wi-Fi baseband signals through a newly added HBC frontend 601. A Wi-Fi baseband may be transmitted/received through RF frontend 602 at 2.5 GHZ, 5 GHz, and 6 GHz.

As shown in FIG. 7, in order to transmit/receive a Wi-Fi or BLE baseband through the newly added HBC frontend 601, a Switching or Routing Control layer 701 may be added below Upper PHY layer 702 of technology, where the Switching Control layer 701 may route the baseband samples to/from (1) RF frontend 602 (as-is) or HBC frontend 601, based on the selected mode of communication. For mode switching or transitioning, the Switching Control 603 may route baseband 802.11 PPDU samples to either the RF frontend 602 or the HBC frontend 601, based on which communication mode is selected for the communication link.

In this solution with baseband between HBC and Wi-Fi (or BLE), in order to optimize the performance of each mode, some PHY processing may also be made mode-specific, and thus moved to a Lower PHY layer 703 sitting below Switching Control layer 701. For example:
On the receiver side, the following processing may be based on whether the PPDU was received on HBC vs RF channel
CFO and doppler shift compensation
Channel estimation
Noise filtering
On the transmitter side, only select simplified configurations may be applied to the PPDUs sent over HBC, e.g., BW limited to 20 MHz, MCS limited up to 4, Spatial Streams limited to 1.

The reason for making these functions mode specific may be, among other reasons, that there is a priori knowledge, such as delay spread statistics, CFO statistics, and mobility statistics that the baseband may use, if the Switching Control unit 603 informs baseband over which mode the signal was received or is to be transmitted.

Some of the baseband processing that is specific to the HBC vs. RF channel may be performed in the respective Lower PHY layer.

Some communication modes may suffer from a sudden link failure or outages. For example, in case of the HBC, when any of the peer devices moves away from the human body, the link performance may degrade quickly. In one embodiment, a wearable device may have a failure detection module configured to predict an upcoming link failure. For example, in case of the HBC, there may be a specific signature in the estimated channel as a receiver that may indicate that there may be an impending link failure.

When such an impending link failure is detected, one or more of the following may be pursued:
The communication may switch to a backup link until an alternative link is found.
The communication selection module may be triggered to select the next best link to use, with the assumption that current module may not be available.

In one embodiment, the aforementioned approaches may be followed in other scenarios, such as if the link is expected to have high channel variability. For example, the HBC channel may have high variability of the subject moves or change the subject's environment.

In one embodiment, the device which detects the link failure may be different from the one which is responsible for the communication mode switch. Correspondingly, the detecting device may transmit a message to the peer device indicating an impending link failure, and thus requesting it to initiate the communication mode switch.

In one embodiment, the wearable device may change the periodicity of channel sounding on one or more communication modes based on the variability of the channel, and/or the likelihood of a link failure. For example, if the HBC channel is observed to have significant variations or is expected to have significant variations via side information, then the frequency of channel sounding or scanning performed on the HBC link may be increased.

Note that having multiple communication modes at the wearable device may lead to significant power consumption if all of the communication modes are always on. Correspondingly, a wearable device may turn off one or more of the communication chips, such as the Wi-Fi, BLE and HBC chips, by default and may turn them on only during discovery/scanning process associated with those communication modes. In the case of Wi-Fi, this periodic turning on may be realized, for example, using a Target Wake Time procedure. In one embodiment, instead of turning off one or more communication modes completely, the communication mode may be operated in a low power state where the chip capabilities are limited, but it has a significantly low power consumption, such as the EMLSR or DPS mode for the Wi-Fi chip. In particular, the power saving method used may be different for the different communication mode depending on:
Power consumption of the communication mode,
Power saving mechanisms available for the communication mode,
Whether the communication mode has been tagged as the Backup link or Discovery link,
Traffic requirements at the wearable device,
Battery level of the wearable device,
Other contextual information, etc.

There may be multiple power saving states defined for each communication mode such as Deep Sleep, Shallow Sleep, Low Capability, Full Capability etc. There may be a power saving module responsible for managing how each communication mode switches between these different power saving states.

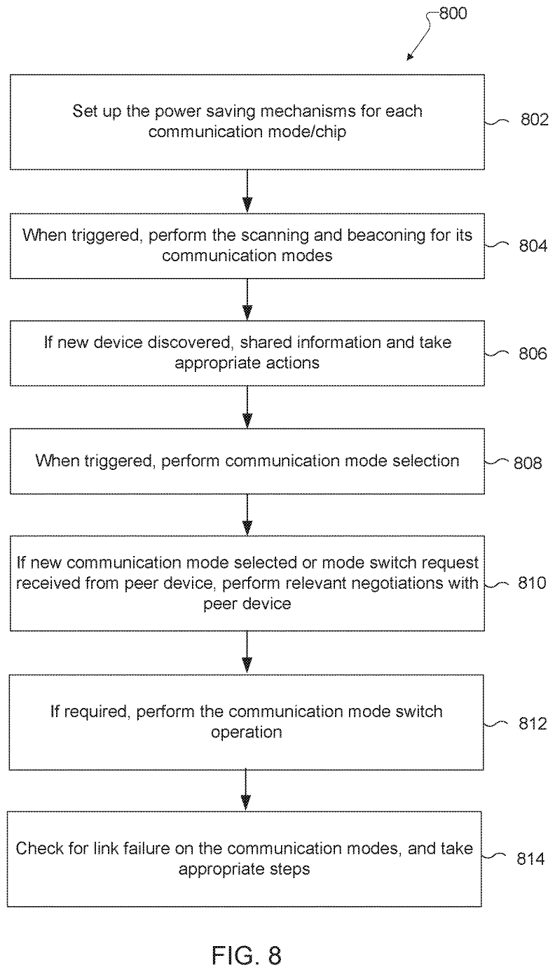

FIG. 8 illustrates a flow diagram of a communication method 800 performed by a wearable device and a peer device in accordance with example embodiments of the present disclosure. The embodiment of the example communication method in FIG. 8 is for illustration only. Other embodiments of the communication method may be used without departing from the scope of this disclosure.

In the example of FIG. 8, the method 800 may begin at step 802. At step 802, an electronic device (e.g., a wearable device such as AR glasses) may set up the power saving mechanisms for each communication mode and/or chip. The power saving mechanisms may include, e.g., the wearable device turning off one or more of the communication chips, such as the Wi-Fi, BLE and HBC chips, by default and turning them on only during discovery/scanning process associated with those communication modes. At step 804, the electronic device may, when triggered, perform the scanning and beaconing for its communication modes. The discovery may be performed periodically without a triggering event.

At step 806, the electronic device may, if a new device (e.g., a peer device such as a smart phone) is discovered, share information and take appropriate actions. For example, the electronic device may share data exchange information, communication modes available, or information such as throughput or latency. At step 808, the electronic device may, when triggered, perform communication mode selection. At step 810, the electronic device may, if a new communication mode is selected or a mode switch request is received from the peer device, perform relevant negotiations with the peer device.

At step 812, the electronic device may, if required, perform the communication mode switch operation. For example, the electronic device may enable the HBC mode by adding HBC frontend via a switching control. At step 814, the electronic device may check for link failure on the communication modes and take appropriate steps.

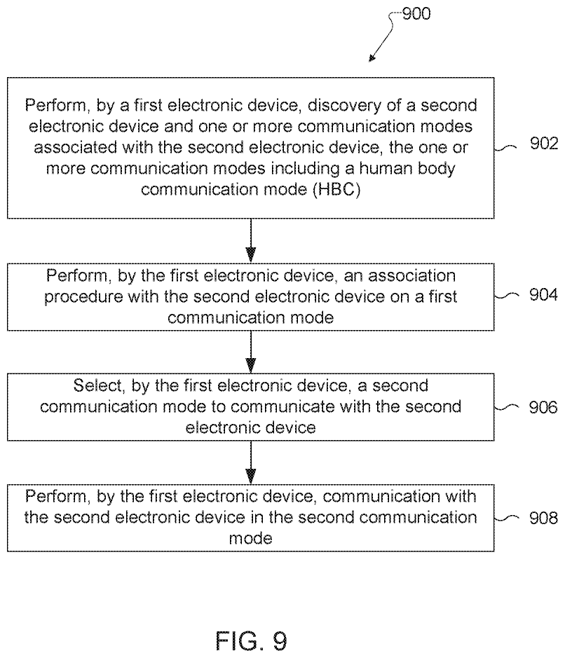

FIG. 9 illustrates a flow chart of an example communication method 900 between a wearable device and a peer device in accordance with example embodiments of the present disclosure. The embodiment of the communication method in FIG. 9 is for illustration only. Other embodiments of the communication methods may be used without departing from the scope of this disclosure. In the example of FIG. 9, the communication method 900 may be performed by a first electronic device (such as AR glasses).

In the example of FIG. 9, the method 900 may begin at step 902. At step 902, the first electronic device may perform discovery of a second electronic device and one or more communication modes associated with the second electronic device, the one or more communication modes including a HBC. The second electronic device may be a peer device such as a smart phone. In one embodiment, the discovery may be performed by periodically performing scanning for each of the one or more communication modes where scanning periodicity may be adaptive or different for each communication mode, and determined based on at least one or more of an applicable communication mode, a battery state of the first electronic device, and a traffic of the first electronic device. In one embodiment, the discovery may be performed by performing scanning based on a trigger including a traffic arrival, a battery power below a threshold, a degradation of key performance indicators below corresponding thresholds, and a presence of the second electronic device.

At step 904, the first electronic device may perform an association procedure with the second electronic device on a first communication mode. In one embodiment, the first electronic device may determine to perform the association with the second electronic device after the discovery by exchanging information including at least one of identifiers and device types, capabilities, one or more communication modes associated with the first electronic device and the one or more communication modes associated with the second electronic device. Alternatively, the first electronic device may determine to perform the association with the second electronic device after the discovery by triggering the association between the first and second electronic devices based on the information.

At step 906, the first electronic device may select a second communication mode to communicate with the second electronic device. In one embodiment, selecting the second communication mode may be performed periodically or upon a trigger, and based on at least one of: the first communication mode between the first and second electronic devices; one or more communication modes associated with the first electronic device and the one or more communication modes associated with the second electronic device; a battery state of the first electronic device; a battery state of the second electronic device; a traffic to be utilized for the first and second electronic devices; communication mode parameters including at least one of supported throughput, latency, average power consumption, and link reliability; time elapsed since a last communication mode switch; costs including power and latency associated with a communication mode switch; and a presence of an existing link or association between the first and second electronic devices.

In one embodiment, the second communication mode may be selected by transmitting an indication to the second electronic device via the first communication mode between the first and second electronic devices. The indication may include a mode switch request. The mode switch request may include at least one of: an identifier of the first electronic device; an identifier of the second electronic device; an indication of the first communication mode for data flows; an indication of a parameter associated with the first communication mode; an indication of the data flows to be rerouted to the first communication mode; a dialog token identifying the mode switch request; an indication of a time stamp at which the mode switch request is made; a reason code indicating a reason for the mode switch request; and an indication of an urgency of the mode switch and negotiability of the mode switch request.

In one embodiment, the second communication mode may be the HBC mode, and transmission on the second communication mode may include adding an HBC frontend as an optional front end to a communication link having a different frontend, adding a routing control between an upper PHY layer and a lower PHY layer of a wireless communication link to enable switching of the frontends; and routing baseband samples from the different frontend to the HBC frontend based on the HBC mode using the routing control.

In one embodiment, a link failure may be predicted and based on the predicted link failure, the first electronic device may perform at least one of: switching to a backup link until a new link is found, transmitting a message to the second electronic device indicating an impending link failure, or selecting a next link for the first and second electronic devices.

In one embodiment, one or more communication modes associated with the first electronic device may be turned on only during the discovery or during active communication with a communication mode. In another embodiment, the first electronic device may determine to operate the one or more communication modes associated with the first electronic device in a power saving state based on at least one of: a power consumption of a corresponding communication mode, power saving mechanisms available for the corresponding communication mode, whether a communication mode has been tagged as a backup link or for discovery of new devices, a traffic to be utilized for the active data traffic at the first electronic device, or a battery level of the first electronic device.

At step 908, the first electronic device may perform communication with the second electronic device in the second communication mode.

Although the present disclosure has been described with exemplary embodiments, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claims scope. The scope of patented subject matter is defined by the claims. None of the description in this application should be read as implying that any particular element, step, or function is an essential element that must be included in the claim scope. The scope of patented subject matter is defined only by the claims.

What is claimed is:

1. A method comprising:
performing, by a first electronic device, discovery of a second electronic device and one or more communication modes associated with the second electronic device, the one or more communication modes including a human body communication mode (HBC);
performing, by the first electronic device, an association procedure with the second electronic device on a first communication mode;
selecting, by the first electronic device, a second communication mode to communicate with the second electronic device; and
performing, by the first electronic device, communication with the second electronic device in the second communication mode.

2. The method of claim 1, wherein performing the discovery comprises:
periodically performing scanning for each of the one or more communication modes, scanning periodicity being adaptive or different for each communication mode, determined based on at least one or more of an applicable communication mode, a battery state of the first electronic device, and a traffic of the first electronic device, or
performing scanning based on a trigger including a traffic arrival, a battery power below a threshold, a degradation of key performance indicators below corresponding thresholds, and a presence of the second electronic device.

3. The method of claim 1, wherein the first electronic device determines to perform the association with the second electronic device after the discovery by:
exchanging information including at least one of identifiers and device types, capabilities, one or more communication modes associated with the first electronic device and the one or more communication modes associated with the second electronic device; and
triggering the association between the first and second electronic devices based on the information.

4. The method of claim 1, wherein:
selecting the second communication mode is performed periodically or upon a trigger, and is based on at least one of:
the first communication mode between the first and second electronic devices;
one or more communication modes associated with the first electronic device and the one or more communication modes associated with the second electronic device;
a battery state of the first electronic device;
a battery state of the second electronic device;
a traffic to be utilized for the first and second electronic devices;
communication mode parameters including at least one of supported throughput, latency, average power consumption, and link reliability;
time elapsed since a last communication mode switch;
costs including power and latency associated with a communication mode switch; and
a presence of an existing link or association between the first and second electronic devices.

5. The method of claim 1, wherein:
selecting the second communication mode comprises transmitting an indication to the second electronic device via the first communication mode between the first and second electronic devices;
the indication comprises a mode switch request; and
the mode switch request comprises at least one of:
an identifier of the first electronic device;
an identifier of the second electronic device;
an indication of the first communication mode for data flows;
an indication of a parameter associated with the first communication mode;
an indication of the data flows to be rerouted to the first communication mode;
a dialog token identifying the mode switch request;
an indication of a time stamp at which the mode switch request is made;
a reason code indicating a reason for the mode switch request; and
an indication of an urgency of the mode switch and negotiability of the mode switch request.

6. The method of claim 1, wherein:
the second communication mode is the HBC mode; and
transmission on the second communication mode comprises:
adding an HBC frontend as an optional front end to a communication link having a different frontend;
adding a routing control between an upper physical (PHY) layer and a lower PHY layer of a wireless communication link to enable switching of the frontends; and
routing baseband samples from the different frontend to the HBC frontend based on the HBC mode using the routing control.

7. The method of claim 1, further comprising:
predicting a link failure; and
based on the predicted link failure, performing at least one of:
switching, by the first electronic device, to a backup link until a new link is found,
transmitting a message by the first electronic device to the second electronic device indicating an impending link failure, or
selecting, by the first electronic device, a next link for the first and second electronic devices.

8. The method of claim 1, further comprising:
turning on one or more communication modes associated with the first electronic device only during the discovery or during active communication with a communication mode; or
determining to operate the one or more communication modes associated with the first electronic device in a power saving state based on at least one of:
a power consumption of a corresponding communication mode,
power saving mechanisms available for the corresponding communication mode,
whether a communication mode has been tagged as a backup link or for discovery of new devices,
a traffic to be utilized for active data traffic at the first electronic device, or
a battery level of the first electronic device.

9. A first electronic device comprising:
memory; and
a processor operably coupled to the memory, the processor configured to:
perform discovery of a second electronic device and one or more communication modes associated with the second electronic device, the one or more communication modes including a human body communication mode (HBC);
perform an association procedure with the second electronic device on a first communication mode;
select a second communication mode to communicate with the second electronic device; and
perform communication with the second electronic device in the second communication mode.

10. The first electronics device of claim 9, wherein to perform the discovery the processor is further configured to:
periodically perform scanning for each of the one or more communication modes, scanning periodicity being adaptive or different for each communication mode, determined based on at least one or more of an applicable communication mode, a battery state of the first electronic device, and a traffic of the first electronic device, or
perform scanning based on a trigger including a traffic arrival, a battery power below a threshold, a degradation of key performance indicators below corresponding thresholds, and a presence of the second electronic device.

11. The first electronics device of claim 9, wherein to determine to perform the association with the second electronic device after the discovery, the processor is further configured to:
exchange information including at least one of identifiers and device types, capabilities, one or more communication modes associated with the first electronic device and the one or more communication modes associated with the second electronic device; and
trigger the association between the first and second electronic devices based on the information.

12. The first electronics device of claim 9, wherein to select the second communication mode, the processor is further configured to perform the selection of the second communication mode periodically or upon a trigger, and the selection is based on at least one of:
the first communication mode between the first and second electronic devices;
one or more communication modes associated with the first electronic device and the one or more communication modes associated with the second electronic device;
a battery state of the first electronic device;
a battery state of the second electronic device;
a traffic to be utilized for the first and second electronic devices;
communication mode parameters including at least one of supported throughput, latency, average power consumption, and link reliability;
time elapsed since a last communication mode switch;
costs including power and latency associated with a communication mode switch; and
a presence of an existing link or association between the first and second electronic devices.

13. The first electronics device of claim 9, wherein:
to select the second communication mode, the processor is further configured to transmit an indication to the second electronic device via the first communication mode between the first and second electronic devices;
the indication comprises a mode switch request; and
the mode switch request comprises at least one of:
an identifier of the first electronic device;
an identifier of the second electronic device;
an indication of the first communication mode for data flows;
an indication of a parameter associated with the first communication mode;
an indication of the data flows to be rerouted to the first communication mode;
a dialog token identifying the mode switch request;
an indication of a time stamp at which the mode switch request is made;
a reason code indicating a reason for the mode switch request; and
an indication of an urgency of the mode switch and negotiability of the mode switch request.

14. The first electronic device of claim 9, wherein:
the second communication mode is the HBC mode; and
to transmit on the second communication mode, the processor is further configured to:
add an HBC frontend as an optional front end to a communication link having a different frontend;
add a routing control between an upper physical (PHY) layer and a lower PHY layer of a wireless communication link to enable switching of the frontends; and
rout baseband samples from the different frontend to the HBC frontend based on the HBC mode using the routing control.

15. The first electronic device of claim 9, wherein the processor is further configured to:
predict a link failure; and
based on the predicted link failure, perform at least one of:
switching to a backup link until a new link is found,
transmitting a message by the first electronic device to the second electronic device indicating an impending link failure, or
selecting a next link for the first and second electronic devices.

16. A non-transitory computer readable medium embodying a computer program, the computer program comprising program code that, when executed by a processor of a first electronic device, causes the first electronic device to:
perform discovery of a second electronic device and one or more communication modes associated with the second electronic device, the one or more communication modes including a human body communication mode (HBC);
perform an association procedure with the second electronic device on a first communication mode;
select a second communication mode to communicate with the second electronic device; and
perform communication with the second electronic device in the second communication mode.

17. The non-transitory computer readable medium of claim 16, wherein the program code that, when executed by the processor of the first electronic device, causes the first electronic device to perform discovery comprises program code that, when executed by the processor of the first electronic device, causes the first electronic device to:
periodically perform scanning for each of the one or more communication modes, scanning periodicity being adaptive or different for each communication mode, determined based on at least one or more of an applicable communication mode, a battery state of the first electronic device, and a traffic of the first electronic device, or
perform scanning based on a trigger including a traffic arrival, a battery power below a threshold, a degradation of key performance indicators below corresponding thresholds, and a presence of the second electronic device.

18. The non-transitory computer readable medium of claim 16, further comprising:
program code that, when executed by the processor of the first electronic device, causes the first electronic device to:
determine to perform the association with the second electronic device after the discovery, and
the program code that, when executed by the processor of the first electronic device, causes the first electronic device to determine to perform the association comprises program code that, when executed by the processor of the first electronic device, causes the first electronic device to:
exchange information including at least one of identifiers and device types, capabilities, one or more communication modes associated with the first electronic device and the one or more communication modes associated with the second electronic device; and
trigger the association between the first and second electronic devices based on the information.

19. The non-transitory computer readable medium of claim 16, wherein:
the program code that, when executed by the processor of the first electronic device, causes the first electronic device to select the second communication mode comprises program code that, when executed by the processor of the first electronic device, causes the first electronic device to to select the second communication mode periodically or upon a trigger, and
the selection of the second communication mode is based on at least one of:
the first communication mode between the first and second electronic devices;
one or more communication modes associated with the first electronic device and the one or more communication modes associated with the second electronic device;
a battery state of the first electronic device;
a battery state of the second electronic device;
a traffic to be utilized for the first and second electronic devices;
communication mode parameters including at least one of supported throughput, latency, average power consumption, and link reliability;
time elapsed since a last communication mode switch;
costs including power and latency associated with a communication mode switch; and
a presence of an existing link or association between the first and second electronic devices.

20. The non-transitory computer readable medium of claim 16, wherein:
the program code that, when executed by the processor of the first electronic device, causes the first electronic device to determine to select the second communication mode comprises program code that, when executed by the processor of the first electronic device, causes the first electronic device to transmit an indication to the second electronic device via the first communication mode between the first and second electronic devices;
the indication comprises a mode switch request; and
the mode switch request comprises at least one of:
an identifier of the first electronic device;
an identifier of the second electronic device;
an indication of the first communication mode for data flows;
an indication of a parameter associated with the first communication mode;
an indication of the data flows to be rerouted to the first communication mode;
a dialog token identifying the mode switch request;
an indication of a time stamp at which the mode switch request is made;
a reason code indicating a reason for the mode switch request; and
an indication of an urgency of the mode switch and negotiability of the mode switch request.
